(19) United States
(12) Patent Application Publication
(10) Pub. No.: US 2009/0095870 A1
(43) Pub. Date: Apr. 16, 2009

(54) STAND AND DISPLAY DEVICE USING THE SAME

(75) Inventor: Kuo-Chou Chang, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/107,085

(22) Filed: Apr. 22, 2008

(30) Foreign Application Priority Data
Oct. 12, 2007 (TW) 96217064

(51) Int. Cl. F16M 11/22

(52) U.S. Cl. 248/440

(57) ABSTRACT

A stand suitable for erecting a display unit of a display device on a platform is provided. The stand is provided with a base and at least a post. The post is provided with a base portion and a bar portion. The base portion is fastened to the base. The bar portion is fastened to the display unit, and has one end connected to the base portion. An orthographic projection area of the base portion to the base is greater than that of the bar portion to the base so as to increase the structure strength of the stand.

### CROSS-REFERENCE TO RELATED APPLICATION

This application claims the priority benefit of Taiwan application serial no. 96217064, filed on Oct. 12, 2007. The entirety the above-mentioned patent application is hereby incorporated by reference herein and made a part of specification.

### BACKGROUND OF THE INVENTION

1. Field of the Invention

The present invention is related to a display device, and more particularly to a stand suitable for supporting a display unit of a display device.

2. Description of Related Art

Along with the progress of science and technology, the display technique has been continuously developed. Among them, light and thin flat panel displays (FPD) have gradually substituted for the conventional cathode ray tubes (CRT) which are thick and heavy. Usually, the flat panel displays (FPD) may be classified into two categories including the plasma display panels (PDP) and the liquid crystal displays (LCD).

Since the flat panel displays are light and thin, usually a stand is added at the back of a flat panel display to stably mount the flat panel display at a required position. The common method for supporting the flat panel display includes simply laying, wall-mounting, and hanging with different stands.

For the stand simply laid on a platform, the end of a post made of metal and having a consistent outer diameter is directly fastened to a metal base through a single bolt, and the other portion of the post far away from the base is fastened to the back of the display unit of the display, so as to erect the display unit on the platform through the base and the post fastened to the base.

However, the joint area between the end of the post and the base is not large, and only a single bolt is used to fasten the end of the post to the base. Therefore, the stand having the post with an extremely small outer diameter may not bear the overall vertical weight of the display unit and may not resist the torque produced on the stand when an external force is exerted on the display unit.

### SUMMARY OF THE INVENTION

In an embodiment of the present invention is directed to a display device and a stand thereof for erecting a display unit of the display device on a platform.

In an embodiment of the present invention provides a stand suitable for erecting a display unit of a display device on a platform. The stand is provided with a base and at least a post. The post is provided with a base portion and a bar portion. The base portion is fastened to the base. The bar portion is fastened to the display unit, and has one end connected to the base portion. An orthographic projection area of the base portion to the base is greater than that of the bar portion to the base.

In an embodiment of the present invention provides a display device, including a display unit and the aforementioned stand.

Since an orthographic projection area of the base portion of the post of the stand to the base is greater than that of the bar portion having one end connected to the base portion to the base, when the base portion is fastened to the base of the stand, the bottom area of the base portion of the post fastened to the base is increased, thereby increasing the structure strength of the stand.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a display device using a stand according to an embodiment of the present invention.

FIG. 2 is an exploded view of a part of the stand of the display device in FIG. 1.

FIG. 3 is a schematic view of a first sub-post and a second sub-post of the post in FIG. 2.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

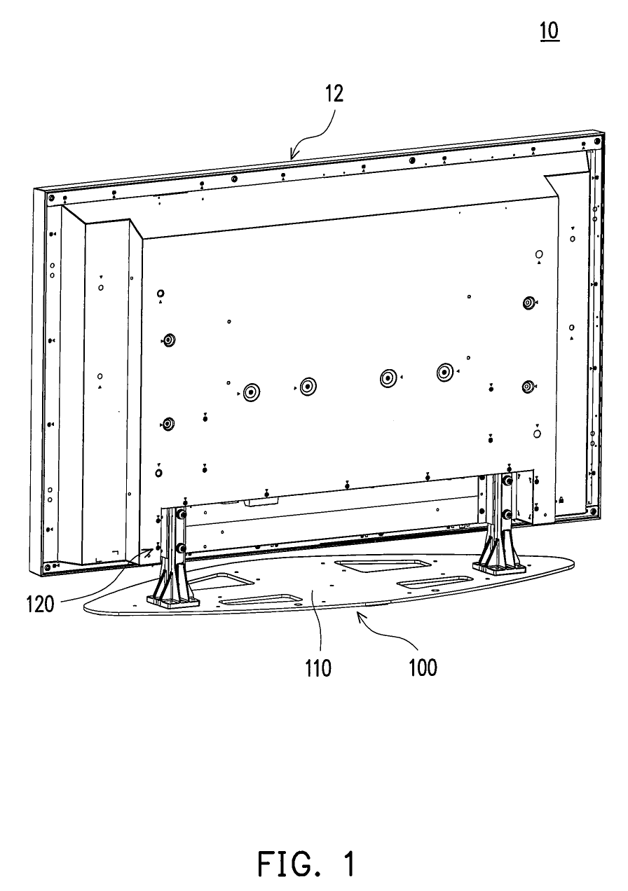

FIG. 1 is a perspective view of a display device using a stand according to an embodiment of the present invention. Referring to FIG. 1, the display device 10 of the present embodiment includes a display unit 12, for example, a liquid crystal display (LCD) or a plasma display panel (PDP). Moreover, the display device 10 further includes a stand 100 for erecting the display unit 12 on a platform. The stand 100 includes a base 110 and two posts 120 disposed between the base 110 and the display element 12.

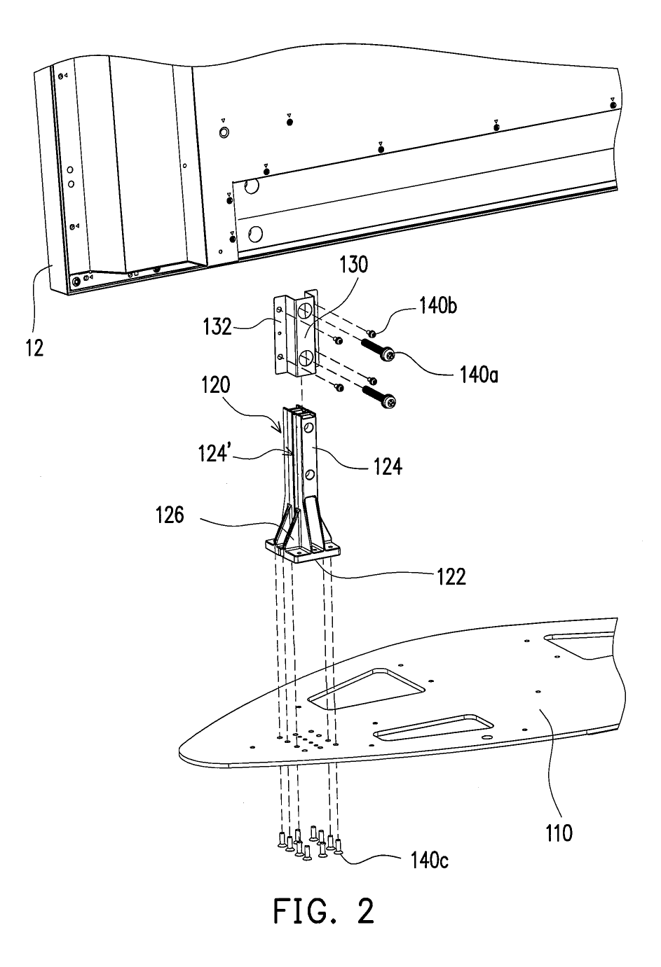

FIG. 2 is an exploded view of a part of the stand of the display device in FIG. 1. Referring to FIG. 2, each post 120 includes a base portion 122 and a bar portion 124 having one end connected to the base portion 122. The base portion 122 is fastened to the base 110 through a plurality of fastening elements 140c, and at least one fastening element 140c is not located at the region where the end of the bar portion 124 and the base portion 122 are connected. The upper segment of the bar portion 124 is fastened to the display unit 12 through a plurality of fastening elements 140a. An orthographic projection area of the base portion 122 to the base 110 is greater than that of the bar portion 124 to the base 110 so as to increase the structure strength of the post 120. Moreover, each post 120 further includes a plurality of rib portions 126 having two neighboring sides respectively connected to the bar portion 124 and the base portion 122, so as to increase the structure strength of the post 120. In this embodiment, the base portion 122, the bar portion 124, and the rib portions 126 are integrally formed.

In this embodiment, the stand 100 further includes two reinforcement patches 130 respectively corresponding to the bar portions 124 of the two posts 120 for auxiliarily fixing the bar portions 124 to the display unit 12. The reinforcement patches 130 are inserted into a fixed slit 124′ of the bar portion 124. A plurality of fastening elements 140a pass through the bar portion 124 and a portion of the reinforcement patches 130 located in the fixed slit 124′, so as to fasten the bar portion 124 and the reinforcement patches 130 to the display unit 12. Moreover, each of the reinforcement patches 130 further includes two wing portions 132 respectively located on two sides of the fixed slit 124′ and extending to the two sides of the bar portion 124 from the fixed slit 124′. The wing portions 132 of the reinforcement patches 130 are fastened to the display unit 12 through the fastening elements 140b.

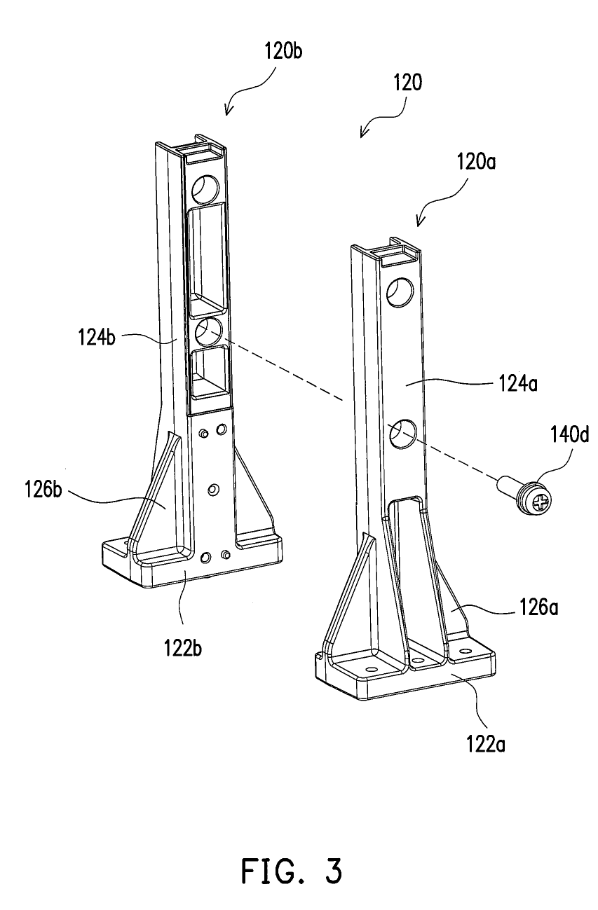

FIG. 3 is a schematic view of a first sub-post and a second sub-post of the post in FIG. 2. Referring to FIGS. 2 and 3, in this embodiment, the post 120 includes a first sub-post 120a which can be fabricated by molding.

The first sub-post 120a has a first sub-base portion 122a and a first sub-bar portion 124a. One end of the first sub-bar portion 124a is connected to the first sub-base portion 122a. An orthographic projection area of the first sub-base portion 122a to the base 110 is greater than that of the first sub-bar portion 124a to the base 110, so as to increase the structure strength of the first sub-post 120a. Moreover, the first sub-post 120a further has a first sub-rib portion 126a having two neighboring sides respectively connected to the first sub-bar portion 124a and the first sub-base portion 122a, thereby increasing the structure strength of the first sub-post 120a.

In this embodiment, the post 120 further includes a second sub-post 120b. The first sub-post 120a and the second sub-post 120b have substantially the same shape, and may be fabricated with the same mold. The first sub-post 120a and the second sub-post 120b are fastened together through the fastening element 140d.

Similar to the first sub-post 120a, the second sub-post 120b has a second sub-base portion 122b and a second sub-bar portion 124b. One end of the second sub-bar portion 124b is connected to the second sub-base portion 122b, and an orthographic projection area of the second sub-base portion 122b to the base 110 is greater than that of the second sub-bar portion 124b to the base 110 so as to increase the structure strength of the second sub-post 120b. Moreover, the second sub-post 120b further has a second sub-rib portion 126b having two neighboring sides respectively connected to the second sub-bar portion 124b and the second sub-base portion 122b, thereby increasing the structure strength of the second sub-post 120b.

When the first sub-post 120a and the second sub-post 120b are fastened together through the fastening element 140d, the first sub-base portion 122a and the second sub-base portion 122b constitute the base portion 122 in FIG. 2, and the first sub-bar portion 124a and the second sub-bar portion 124b constitute the base portion in FIG. 2.

In view of the above, since an orthographic projection area of the base portion of the post of the stand to the base is greater than that of the bar portion having one end connected to the base portion to the base, when the base portion is fastened to the base of the stand, the bottom area of the base portion fastened to the base is increased, thereby increasing the structure strength of the stand. Therefore, the stand of the present invention bears the weight of the display unit and resists the torque produced on the stand when an external force is exerted on the display unit.

Additionally, the post is separated into two sub-posts for fabricating, which contributes to forming the fixed slit on the bar portion, and reducing the fabricating difficulty of the post. Furthermore, the post is separated into two identical sub-posts, and the two identical sub-posts may be fabricated with the same mold, thus reducing the cost.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A stand, suitable for erecting a display unit of a display device on a platform, comprising:
a base; and
at least one post, comprising:
a base portion, fastened to the base; and
a bar portion, fastened to the display unit, and having one end connected to said base portion, wherein an orthographic projection area of said base portion to said base is greater than that of said bar portion to said base.

2. The stand as claimed in claim 1, further comprising:
a reinforcement patch, inserted into a fixed slit of said bar portion, and having at least one wing portion located on one side of said bar portion and fastened to said display unit.

3. The stand as claimed in claim 2, further comprising:
a fastening element, passing through said bar portion and a portion of said reinforcement patch located in said fixed slit, so as to fasten said bar portion and said reinforcement patch to said display unit.

4. The stand as claimed in claim 1, wherein said post further comprises:
at least one rib portion, having two neighboring sides respectively connected to said bar portion and said base portion.

5. The stand as claimed in claim 1, wherein said post further comprises:
a first sub-post, comprising:
a first sub-base portion;
a first sub-bar portion, having one end connected to said first sub-base portion, wherein an orthographic projection area of said first sub-base portion to said base is greater than that of said first sub-bar portion to said base; and
a second sub-post, comprising:
a second sub-base portion, wherein said second sub-base portion and said first sub-base portion constitute said base portion; and
a second sub-bar portion, having one end connected to said second sub-base portion, wherein said second sub-bar portion and said first sub-bar portion constitute said bar portion, and an orthographic projection area of said second sub-base portion to said base is greater than that of said second sub-bar portion to said base.

6. The stand as claimed in claim 5, wherein said first sub-post and said second sub-post have substantially said same shape.

7. The stand as claimed in claim 5, further comprising:
a reinforcement patch, inserted into a fixed slit constituted by said first sub-bar portion and said second sub-bar portion, and having at least one wing portion located on one side of said bar portion.

8. The stand as claimed in claim 7, further comprising:
a fastening element, passing through said first sub-bar portion, said second sub-bar portion, and a portion of said reinforcement patch located in said fixed slit, so as to fasten said first sub-bar portion, said second sub-bar portion, and said reinforcement patch to said display unit.

9. The stand as claimed in claim 5, wherein said first sub-post further comprises:
at least one first rib portion, having two neighboring sides respectively connected to said first sub-bar portion and said first sub-base portion.

10. The stand as claimed in claim 5, wherein said second sub-post further comprises:
at least one second rib portion, having two neighboring sides respectively connected to said second sub-bar portion and said second sub-base portion.

11. A display device, comprising:
a display unit; and
a stand, comprising:
a base; and
at least one post, comprising:
a base portion, fastened to said base; and
a bar portion, fastened to said display unit, and having one end connected to said base portion, wherein an orthographic projection area of said base portion to said base is greater than that of said bar portion to said base.

12. The display device as claimed in claim 11, wherein said stand further comprises:
a reinforcement patch, inserted into a fixed slit of said bar portion, and having at least one wing portion located on one side of said bar portion and fastened to said display unit.

13. The display device as claimed in claim 12, wherein said stand further comprises:
a fastening element, passing through said bar portion and a portion of said reinforcement patch located in said fixed slit, so as to fasten said bar portion and said reinforcement patch to said display unit.

14. The display device as claimed in claim 11, wherein said post further comprises:
at least one rib portion, having two neighboring sides respectively connected to said bar portion and said base portion.

15. The display device as claimed in claim 11, wherein said post further comprises:
a first sub-post, comprising:
a first sub-base portion;
a first sub-bar portion, having one end connected to said first sub-base portion, wherein an orthographic projection area of said first sub-base portion to said base is greater than that of said first sub-bar portion to said base; and
a second sub-post, comprising:
a second sub-base portion, wherein said second sub-base portion and said first sub-base portion constitute said base portion; and
a second sub-bar portion, having one end connected to said second sub-base portion, wherein said second sub-bar portion and said first sub-bar portion constitute said bar portion, and an orthographic projection area of said second sub-base portion to said base is greater than that of said second sub-bar portion to said base.

16. The display device as claimed in claim 15, wherein said first sub-post and said second sub-post have substantially said same shape.

17. The display device as claimed in claim 15, wherein said stand further comprises:
a reinforcement patch, inserted into a fixed slit constituted by said first sub-bar portion and said second sub-bar portion, and having at least one wing portion located on one side of said bar portion.

18. The display device as claimed in claim 17, wherein said stand further comprises:
a fastening element, passing through said first sub-bar portion, said second sub-bar portion, and a portion of said reinforcement patch located in said fixed slit, so as to fasten said first sub-bar portion, said second sub-bar portion, and said reinforcement patch to said display unit.

19. The display device as claimed in claim 15, wherein said first sub-post further comprises:
at least one first sub-rib portion, having two neighboring sides respectively connected to said first sub-base portion and said first sub-bar portion.

20. The display device as claimed in claim 15, wherein said second sub-post further comprises:
at least one second sub-rib portion, having two neighboring sides respectively connected to said second sub-base portion and said second sub-bar portion.
